(19) United States
(12) Patent Application Publication
(10) Pub. No.: US 2011/0235873 A1
(43) Pub. Date: Sep. 29, 2011

(54) EXTRACTING DEVICE-RELATED DATA FROM GRAPHICAL USER INTERFACE

(75) Inventors: Ian JAFFE, Rehovot (IL); Liat ZELIG, Rishon Le Zion (IL); Rivka MONITZ, Moshav Nir Zvi (IL); Assaf SHEEP, Rishon Le Zion (IL)

(73) Assignee: BIO-RAD LABORATORIES (ISRAEL) INC., Rishon Le Zion (IL)

(21) Appl. No.: 12/730,382

(22) Filed: Mar. 24, 2010

(51) Int. Cl. G06K 9/62

(52) U.S. Cl. 382/128

(57) ABSTRACT

A clinical diagnostic device monitoring system comprising: a data retrieving module embeddable in clinical data managing device, the data retrieving module arranged to obtain screen shots relating to clinical diagnostic instruments, from the clinical data managing device at specified periods without interruption to the device's operation, and further arranged to communicate the screen shots via a communication link to a mediator server arranged to receive the screen shots from the data retrieving module; to analyze the screen shots; and to extract instrument related data from the analyzed screen shots, wherein the screen shots analysis allows the extraction of instrument related data without further interface with the clinical data managing device nor with the clinical diagnostic instruments.

### BACKGROUND

1. Technical Field

The present invention relates to the field of data transfer, and more particularly, to data extraction from given clinical diagnostic devices monitoring clinical diagnostic instruments.

2. Discussion of Related Art

Incompatibility between devices of different manufacturers is a major obstacle in the way of using such devices in a single project. Such incompatibility also hinders using output from one of the devices as input to an integrative system.

### BRIEF SUMMARY

Embodiments of the present invention provide a clinical diagnostic device monitoring system comprising: a data retrieving module embeddable in at least one clinical data managing device, the data retrieving module arranged to obtain a plurality of screen shots relating to at least one clinical diagnostic instrument, from the at least one clinical data managing device at specified periods without interruption to the device's operation, and further arranged to communicate the screen shots via a communication link; and a mediator server connected to the data retrieving module via the communication link and arranged to receive the screen shots from the data retrieving module; to analyze the screen shots; and to extract instrument related data from the analyzed screen shots, wherein the screen shots analysis allows the extraction of instrument related data without further interface with the at least one clinical data managing device nor with the at least one clinical diagnostic instrument.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram, illustrating a clinical diagnostic device monitoring system for extracting instrument related data, according to some embodiments of the invention;

FIG. 2 illustrates a screen shot from a clinical diagnostic device, monitoring clinical diagnostic instruments, according to some embodiments of the invention; and

FIG. 3 is a high level schematic flowchart, illustrating a method of extracting instrument data, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

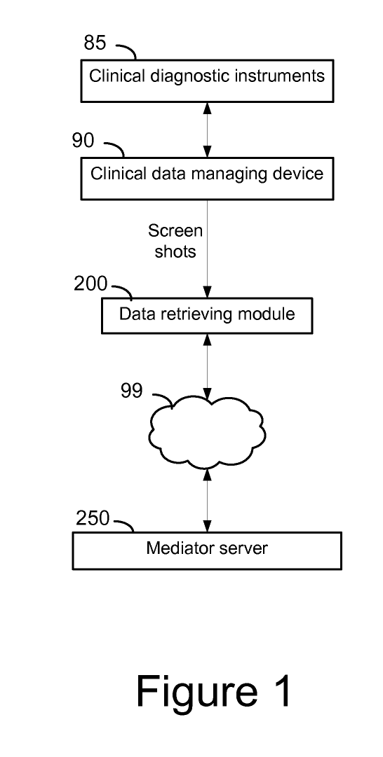

FIG. 1 is a high level schematic block diagram, illustrating a clinical diagnostic device monitoring system for extracting instrument related data, according to some embodiments of the invention. The clinical diagnostic device monitoring system comprises a data retrieving module 200 connected via a communication link 99 to a mediator server 250. Data retrieving module 200 is embeddable in a clinical data managing device 90, that is connected to clinical diagnostic instruments 85. For example, clinical data managing device 90 may comprise Clinical Data Manager (CDM) software that manages and monitors various clinical diagnostic instruments 85 such as instruments for monitoring blood parameters of patients. Data retrieving module 200 is arranged to obtain a plurality of screen shots, that reflect the state of clinical diagnostic instruments 85, from clinical data managing device 90 at specified periods without interruption to device 90's (and instruments 85's) operation, and is further arranged to receive operation related data from device 90 and communicate the screen shots and the operation related data via communication link 99 to mediator server 250.

Mediator server 250 is arranged to receive the screen shots and the operation related data from data retrieving module 200, and is further arranged to analyze the screen shots in view of the operation related data and to extract device related data, comprising device status information, from the analyzed screen shots, wherein the screen shots analysis allows the extraction of device status information without further interface with device 90.

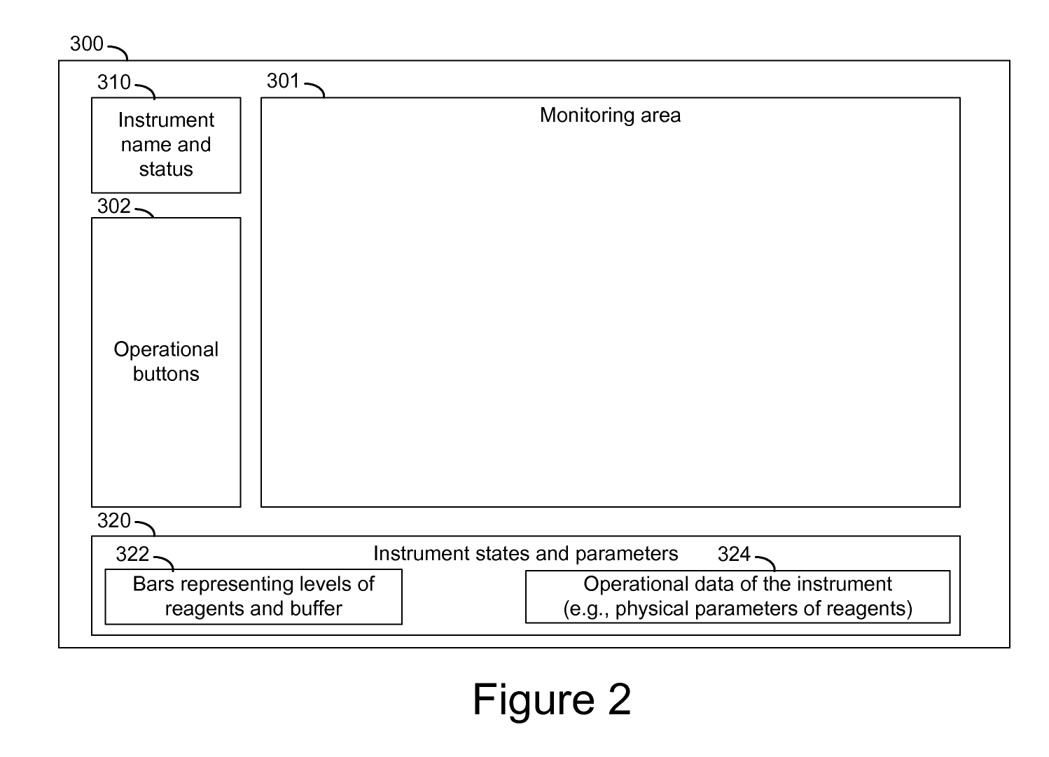

FIG. 2 illustrates a screen shot 300 from device 90, monitoring instrument 85, according to some embodiments of the invention. Screen shot 300 comprises a monitoring area 301, indicating values measured by instrument 85, and various operational buttons 302 relating to device 90's interface. Screen shot 300 further comprises an indication 310 of the instrument's name and status, as well as an area 320 indicating instrument states and parameters. Area 320 may comprise for example bars 322 representing levels of reagents and buffers used by instrument 85, as well as other operational data 324 of instrument 85, such as physical parameters of the reagents (e.g., temperature, pressure, concentration etc.).

Device 90 may monitor and manage various instruments 85, and data retrieving module 200 may identify specific instruments 85 by screen shot parts, e.g., indication 310 of the instrument's name.

The screen shots and operation related data derived therefrom (e.g., from area 320), may be used to proactively perform preventive maintenance such as correcting faults, preparing and filling reagents and buffer, and responding quickly to alerts from instruments 85.

According to some embodiments of the invention, mediator server 250 is further arranged to detect failures in the extracted device related data and to derive remedies to the detected failures.

According to some embodiments of the invention, data retrieving module 200 may comprise an agent capable of acquiring screen data silently at predetermined intervals, upon server 250 request, or upon user request, and transmitting the image data to mediator server 250 which manipulates the data to calculate the device's state and derive rules that execute instructions on remedy problems that may occur or have occurred.

According to some embodiments of the invention, data retrieving module 200 is further arranged to add a visual identification to the communicated screen shots, and mediator server 250 is arranged to analyze the screen shots in view of the visual identification.

Advantageously, the system and method may reduce the customization needed by the agent to interrogate 3rd party software by identifying instrument 85's state through manipulation of image data. A further advantage is the use of a standard agent with minimum processing power on device 90's side to capture and upload data to mediator server 250 where data manipulation and processing occurs. In this way CPU overhead on device 90 is minimized.

According to some embodiments of the invention, the system and method use manipulated image data (screen shots) to identify instrument 85's status and furthermore to report status changes in instrument 85 while avoiding the need to access application software such as log files and databases. Particularly when supporting non-propriety systems, information required to access this data may be limited.

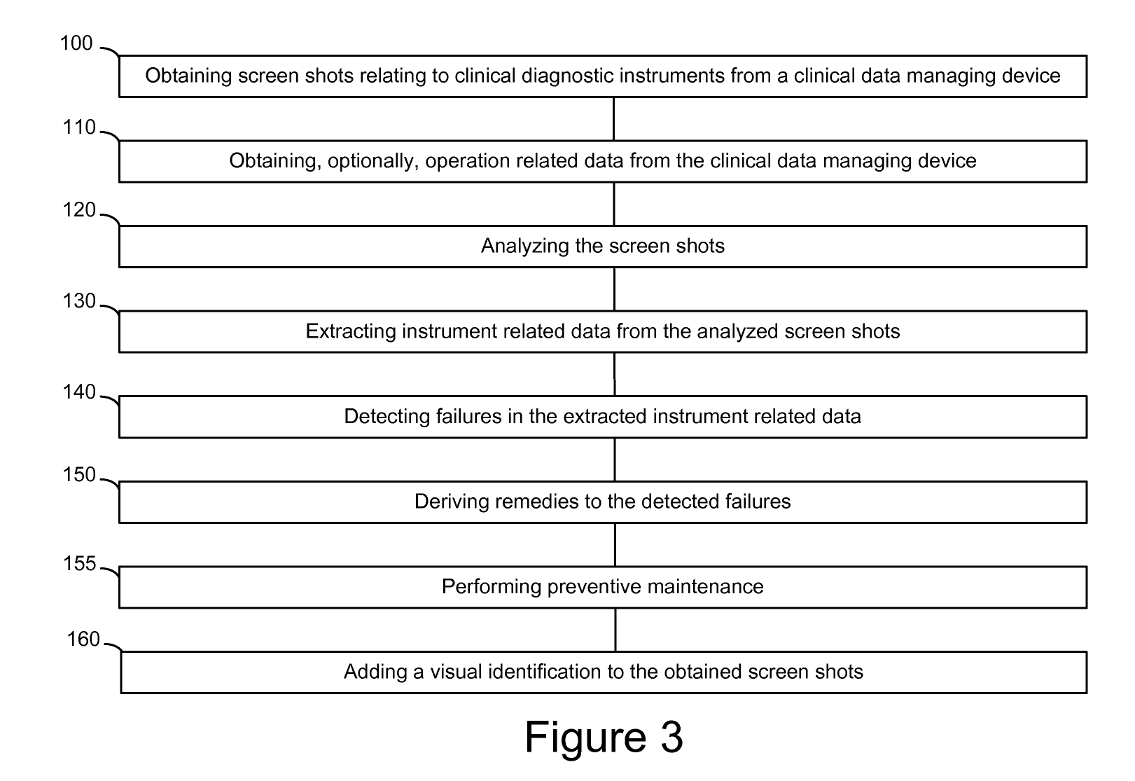

FIG. 3 is a high level schematic flowchart, illustrating a method of extracting instrument data, according to some embodiments of the invention. The method comprises the following stages: obtaining a plurality of screen shots relating to at least one clinical diagnostic instrument from at least one clinical data managing device (stage 100); optionally obtaining operation related data from the clinical data managing device (stage 110); analyzing the screen shots (stage 120) (optionally in view of the operation related data); and extracting instrument related data from the analyzed screen shots (stage 130) such as status information, amounts of reagents and buffers, and physical parameters of reagents and buffers. The screen shots analysis (stage 120) allows the extraction of instrument related data without interface with the instruments and without any further interface with the device. At least one of the stages 110 to 130 is performed by at least one computer.

According to some embodiments of the invention, obtaining the screen shots from the device (stage 100) is carried out at specified periods without interruption to the device's operation.

According to some embodiments of the invention, the method further comprises detecting failures in the extracted instrument related data (stage 140) and may further comprise deriving remedies to the detected failures (stage 150); and performing preventive maintenance (stage 160).

According to some embodiments of the invention, the method further comprises adding a visual identification to the obtained screen shots (stage 160). Analyzing the screen shots (stage 120) utilizes the visual identification. For example, the visual identification may comprise references to formerly identified elements of the screen shots or to formerly analyzed instruments.

According to some embodiments of the invention, the method may be implemented in a computer program product, comprising a computer readable storage medium having computer readable program embodied therewith. The computer readable program comprises computer readable program configured to obtain a plurality of screen shots relating to at least one clinical diagnostic instrument from at least one clinical data managing device; computer readable program configured to analyze the screen shots; and

computer readable program configured to extract instrument related data from the analyzed screen shots, wherein the screen shots analysis allows the extraction of instrument related data without interface with the instruments and without any further interface with the device.

According to some embodiments of the invention, the computer readable program further comprises a computer readable program arranged to add a visual identification to the obtained screen shots, and wherein the computer readable program configured to analyze the screen shots, is further configured to analyze the screen shots in view of the visual identification.

According to some embodiments of the invention, the computer readable program further comprises a computer readable program arranged to generate, from the instrument related data, instrument related indications comprising at least one of: detected failures; suggested remedies to detected failures; and suggested preventive maintenance.

According to some embodiments of the invention, the computer readable program further comprises a computer readable program arranged to obtain operation related data from the at least one clinical diagnostic device, and wherein the computer readable program arranged to analyze the screen shots analyzes the screen shots in view of the operation related data.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A clinical diagnostic device monitoring system comprising:
a data retrieving module embeddable in at least one clinical data managing device, the data retrieving module arranged to obtain a plurality of screen shots relating to at least one clinical diagnostic instrument, from the at least one clinical data managing device at specified periods without interruption to the device's operation, and further arranged to communicate the screen shots via a communication link; and
a mediator server connected to the data retrieving module via the communication link and arranged to receive the screen shots from the data retrieving module; to analyze the screen shots; and to extract instrument related data from the analyzed screen shots,
wherein the screen shots analysis allows the extraction of instrument related data without further interface with the at least one clinical data managing device nor with the at least one clinical diagnostic instrument.

2. The clinical diagnostic device monitoring system of claim 1, wherein the data retrieving module is further arranged to receive operation related data from the at least one clinical data managing device, to communicate the operation related data via a communication link to the mediator server, and wherein the mediator server is arranged to analyze the screen shots in view of the operation related data.

3. The clinical diagnostic device monitoring system of claim 1, wherein the extracted instrument related data comprises at least one of: instrument status information; and instrument's operational data.

4. The clinical diagnostic device monitoring system of claim 1, wherein the mediator server is further arranged to detect failures in the extracted instrument related data and to derive remedies to the detected failures.

5. The clinical diagnostic device monitoring system of claim 1, wherein the data retrieving module is further arranged to add a visual identification to the communicated screen shots, and wherein the mediator server is arranged to analyze the screen shots in view of the visual identification.

6. A method comprising:
obtaining a plurality of screen shots relating to at least one clinical diagnostic instrument from at least one clinical data managing device;
analyzing the screen shots; and
extracting instrument related data from the analyzed screen shots,
wherein the screen shots analysis allows the extraction of instrument related data without interface with the instruments and without any further interface with the device, and
wherein at least one of: the obtaining, the analyzing; and the extracting is performed by at least one computer.

7. The method of claim 6, wherein the obtaining the screen shots from the at least one device is carried out at specified periods without interruption to the device's operation.

8. The method of claim 6, further comprising detecting failures in the extracted instrument related data.

9. The method of claim 8, further comprising deriving remedies to the detected failures.

10. The method of claim 6, further comprising performing preventive maintenance to the instruments according to the extracted instrument related data.

11. The method of claim 6, further comprising adding a visual identification to the obtained screen shots, and wherein the analyzing of the screen shots utilizes the visual identification.

12. The method of claim 6, further comprising obtaining operation related data from the at least one clinical diagnostic device, and wherein the analyzing the screen shots is carried out in view of the operation related data.

13. The method of claim 6, wherein the instrument related data comprises at least one of: status information; amounts of reagents and buffers; and physical parameters of reagents and buffers.

14. A computer program product, the computer program product comprising:
a computer readable storage medium having computer readable program embodied therewith, the computer readable program comprising:
computer readable program configured to obtain a plurality of screen shots relating to at least one clinical diagnostic instrument from at least one clinical data managing device;
computer readable program configured to analyze the screen shots; and
computer readable program configured to extract instrument related data from the analyzed screen shots,
wherein the screen shots analysis allows the extraction of instrument related data without interface with the instruments and without any further interface with the device.

15. The computer program product of claim 14, wherein the computer readable program further comprises a computer readable program arranged to add a visual identification to the obtained screen shots, and wherein the computer readable program configured to analyze the screen shots, is further configured to analyze the screen shots in view of the visual identification.

16. The computer program product of claim 14, wherein the computer readable program further comprises a computer readable program arranged to generate, from the instrument related data, instrument related indications comprising at least one of: detected failures; suggested remedies to detected failures; and suggested preventive maintenance.

17. The computer program product of claim 14, wherein the computer readable program further comprises a computer readable program arranged to obtain operation related data from the at least one clinical diagnostic device, and wherein the computer readable program arranged to analyze the screen shots analyzes the screen shots in view of the operation related data.
